(19) United States
(12) Patent Application Publication
(10) Pub. No.: US 2002/0048996 A1
(43) Pub. Date: Apr. 25, 2002

(54) Phone/modem blocker

(76) Inventor: James W. Beck, Minneapolis, MN (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 09/900,799

(22) Filed: Jul. 6, 2001

Related U.S. Application Data
(60) Provisional application No. 60/216,654, filed on Jul. 7, 2000.

(51) Int. Cl. H01R 13/68

(52) U.S. Cl. 439/621

(57) ABSTRACT

A telephone line protection device which effectively blocks power surge conditions caused by crossed power lines, peripheral lightening strikes, or other types of severe power surges from damaging telephone equipment and computer modems within a home or business.

### CROSS-REFERENCE TO RELATED APPLICATIONS

This application claims priority from U.S. provisional application 60/216,654, filed Jul. 7, 2000, the entire contents of which are incorporated herein by reference.

### BACKGROUND OF THE INVENTION

Electronic equipment and particularly computers, computer modems, electrical circuit boards, and telephones are susceptible to damage resulting from exposure to power surges. Power surges, such as those exceeding 375 volts, may be caused by power lines being crossed, by lightening strikes which may damage nearby electronic circuitry and by other causes as well. In the past, attempts have been made to provide power surge limiting devices proximate to electronic equipment to minimize risk of damage during exposure to severe over-voltage situations. Further, in the past, power surge limiting devices have usually been located or positioned proximate to the telephone or modem and rely on the integrity of the ground wire upstream, proximate to the electrical service entrance.

Ground wires and other grounding means may have or may include variations in impedance. The variations in impedance, in addition to missing components such as ground screws, during power surge conditions, may result in a power surge current pursuing alternative current ground paths through computer mother boards or circuit boards. This may cause damage to the computer mother boards and/or circuit boards. As such, a need exists for power surge protection proximate to the entrance of telephone and/or power lines, and earth ground points to prevent power surge currents from entering phone lines and/or ground wiring within a structure.

The entire content of all of the patents listed within the present patent application are incorporated herein by reference.

### BRIEF SUMMARY OF THE INVENTION

The phone/modem blocker effectively blocks power surge conditions caused by crossed power lines, peripheral lightening strikes, or other types of severe power surges from damaging telephone equipment and computer modems within a home or business.

In at least one embodiment of the invention, the phone/modem blocker provides an operational verification system which indicates line status of a phone line through the use of an indicator, such as a light, which may be activated or tested by the depression of a test switch. Depression of the test switch in turn causes closure of the test circuit to illuminate the test light which in turn signals the absence of a fault or malfunction.

The phone/modem blocker may be positioned proximate to, and may be preferably mounted to an electrical distribution panel providing a firm electrical ground for the phone/modem blocker. One or more incoming phone lines may be received by the phone/modem blocker by one or more incoming phone jacks. The phone/modem blocker may also have one or more output or outgoing jacks for connecting to communication devices such as one or more phones, modem, computers, or other devices.

In at least one embodiment of the invention, the phone/modem blocker utilizes a solid state over voltage protector component or crowbar device such as may be described in U.S. Pat. Nos. 4,685,120, 4,827,497, 4,905,119, 5,479,031 and U.S. Pat. No. 5,516,705 among others. When voltage exceeding the break-over voltage is applied to a over voltage protector component such as a crowbar device, the crowbar device switches from a high off-state impedance to a low on-state impedance creating a short across tip and ring until the current is interrupted or drops below the holding current at which time the crowbar will reset.

In a preferred embodiment of the invention the crowbar device is a Sidactor® device available from Teccor Electronics, Inc. (formerly ECC Electronics Corp.), of Irving, Tex. In the event of a severe power surge, the present invention isolates each telephone line with a protector component, such as a Sidactor®, and fuse configuration to instantly suppress the surge. The protector component immediately reduces the high voltage spike to zero to prevent damage to the connected electrical modems, circuits or other devices. The fuse also insures the protection of the configuration of the circuit board, modem, and/or circuit.

In the past, most low cost protection circuits utilized MOV's in combination with fuses to protect equipment and to isolate phone lines in the event of severe over-voltage exposure from either power line crosses or lightening strikes. In at least one embodiment of the present invention, Sidactors® are used in combination with fuses, as positioned proximate to the electrical distribution panel and earth ground point to isolate and protect phone lines and/or modem lines in the event of severe power surges or over-voltage exposure to prevent damage to electrical components.

Positioning of a phone/modem blocker of the present invention proximate to the telephone line entrance and earth ground point prevents power-surge currents or excessive power currents from entering the phone line and ground wiring within a building thereby preventing further entry into electronic equipment circuits. The combination of the location for the phone/modem blocker proximate to the phone line entrance and ground point, the use of replacement fuses, the easy test verification indicators, and diagnosis means facilitate maximum usefulness of the phone/modem blocker.

In at least one embodiment of the invention, the phone/modem blocker may be a fully integrated system utilizing one or more Sidactors®, fuses, a circuit board, indicators such as LED's, test buttons, and a ground post to effectively prevent excessive currents and/or power surge currents from entering a dwelling and potentially damaging circuitry integral to electronic equipment and/or modems.

### BRIEF DESCRIPTION OF THE SEVERAL VIEWS OF THE DRAWINGS

A detailed description of the invention is hereafter described with specific reference being made to the drawings in which:

FIG. 1 is an isometric view of an embodiment of the phone/modem blocker;

FIG. 2 is an alternative isometric view of an embodiment of the phone/modem blocker having an open cover to display the fuse configuration;

FIG. 3 is a circuit diagram of an embodiment of the phone/modem blocker;

FIG. 4 is a top down view of a silk screen of the circuit diagram of FIG. 3; and

FIG. 5 is an engineering diagram of a circuit board of a phone/modem blocker.

### DETAILED DESCRIPTION OF THE INVENTION

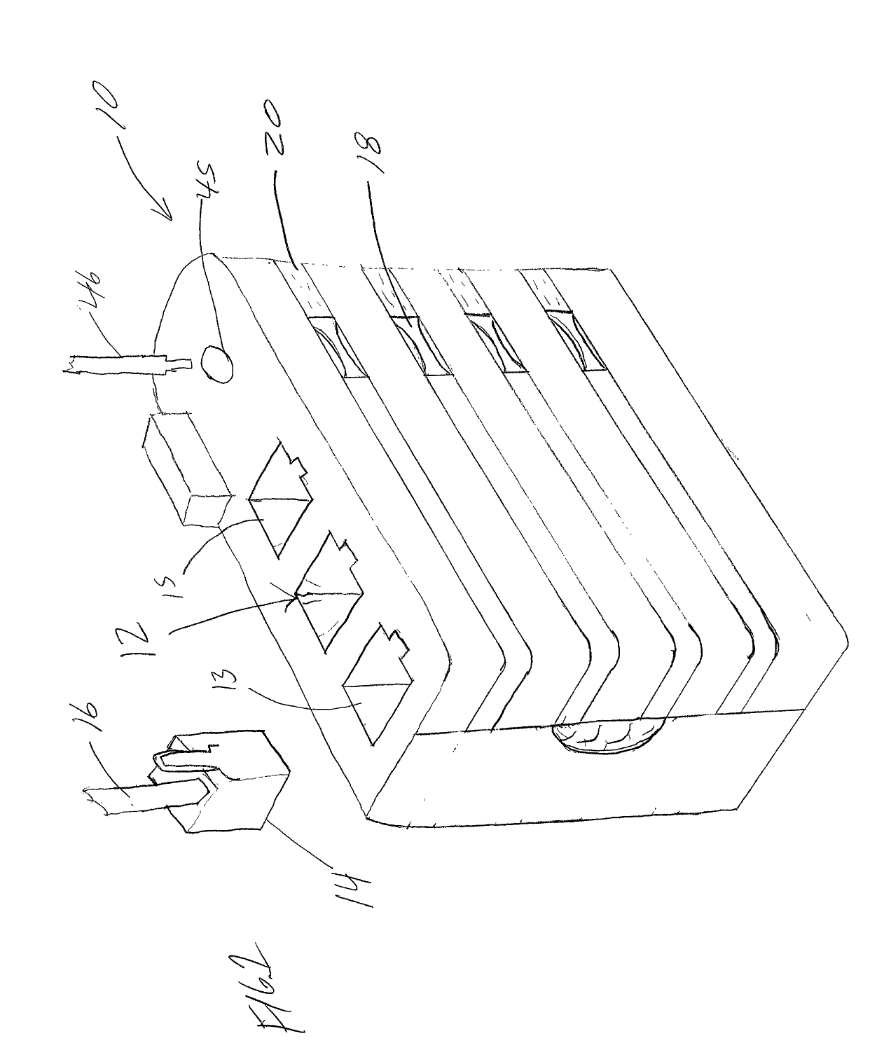

Referring to FIG. 1, an embodiment of the phone/modem blocker is shown general at reference numeral 10. In general, the phone/modem blocker 10 preferably includes a plurality of phone jacks 12 which are preferably adapted to receive the plug connectors 14 of telephone or modem cables 16. Of the jacks 12, at least one jack is an input or line-in jack 13 for receiving the phone line or lines which provide phone service to a dwelling and at least one of the jacks 12 is an out-put or out-going jack 15 for connecting the connector 14 of a phone, modem, computer or other device to the phone/modem blocker 10.

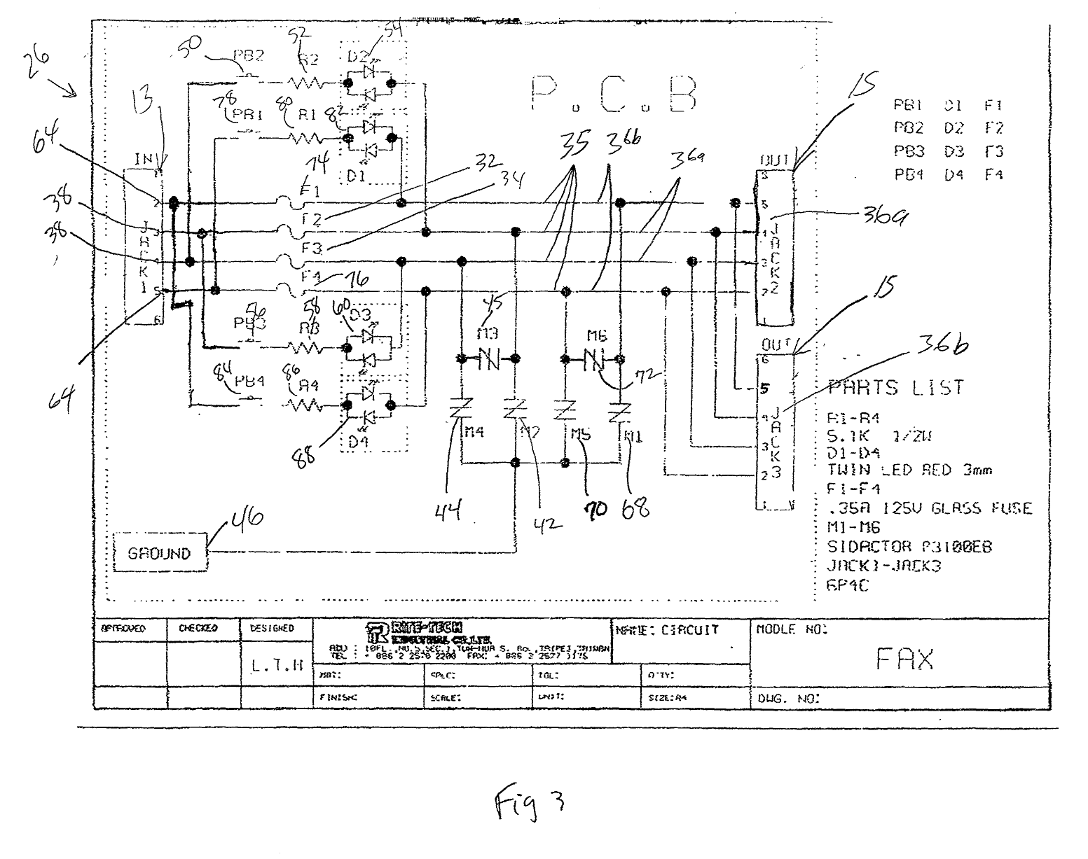

The input jack or jacks 13 may be configured for use with any type of phone or modem cable or line. For example, cable 16 may be RJ11, RJ13, RJ45 or any other type of cable for use in connecting telecommunications devices, connector 14 will be respectively configured depending on the type of cable 16 selected. Depending on the type and number of cables 16 configured to come into the blocker 10, the configuration and number of out-put jacks 13 will proportionally vary. For example it is know that a single RJ11 cable includes four wires 35 (shown in the schematic diagram of FIG. 3). Each pair of wires 35 may form a single line 36 to support a single out-put jack 13. Therefore, a single RJ11 cable can support one or two out-put jacks. A single RJ13 cable, having 6 wires 35, may support up to 3 output jacks. A single RJ45 cable, having 8 wires, could provide as many as 4 out-put jacks. It is thus understood by one of ordinary skill that the configuration of the input jack(s) 13 may be made to accept a variety of connector and associated cable types, and that the number and type of out-put jacks 15 may correspondingly varied.

The phone/modem blocker 10 also preferably includes a plurality of test switches 18 which are in electrical communication with test circuitry for illumination of test indicator lights 20.

Preferably the phone/modem blocker 10 is in electrical communication with an electrical distribution panel and earth ground point which is located to the exterior of a dwelling and/or building (not shown) and engaged by a ground wire 46. An end of the ground wire 46 may be plugged into a ground wire port 45 or otherwise engaged to the blocker 10. As may be seen in FIG. 3, the electric circuit 26 is in electrical communication with the ground wire 46 thereby ensuring proper electrical grounding of the blocker 10.

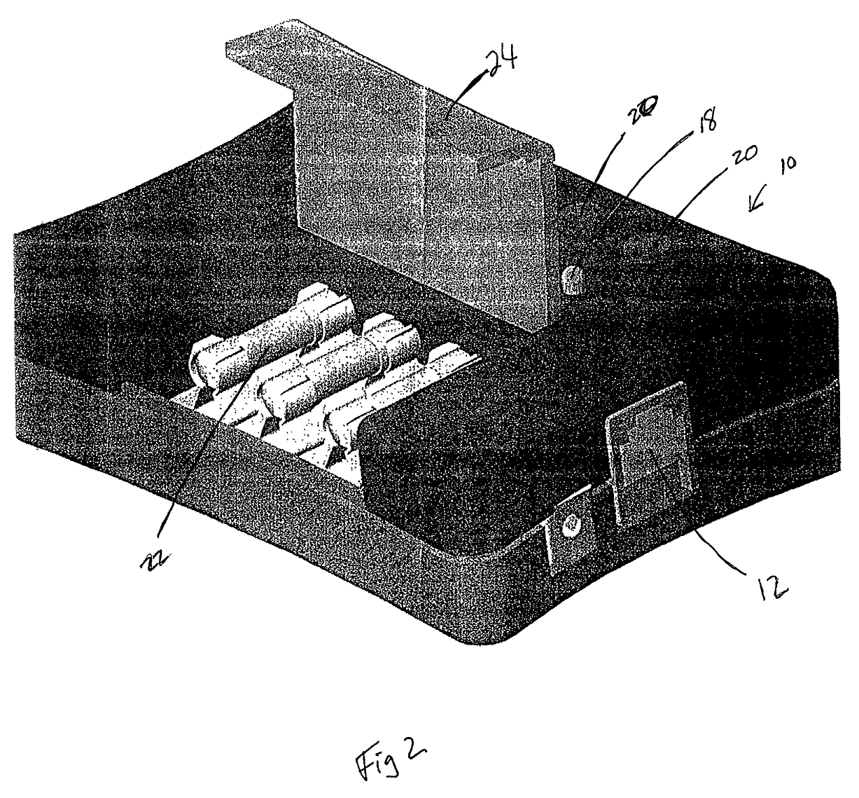

In operation of the phone/modem blocker 10, the integrity of the phone and/or modem lines 36 may be identified through the use of the test switches 18. The depression of the test switches 18 will cause an indicator such as a light emitting diode (LED) or other type of test indicator lights 20 to be illuminated to signal that the fuse 22 (shown in FIG. 2), corresponding to the switch 18 and indicator 20, is in good operational condition. If the test switch 18 is depressed and the test indicator 20 fails to be illuminated or otherwise triggered, such failure indicates that the fuse is in an open condition necessitating replacement.

Referring to the embodiment shown in FIG. 2, the fuses 22 are identified as being internal to the phone/modem blocker 10. Accessibility to the fuses 22 is provided through the use of a retractable cover 24 providing for easy replacement during non-operational conditions. As in the embodiment shown in FIG. 1, each fuse 22 may be tested by activation of a test switch 18 which in turn activates indicator 20 if the fuse 22 is in good operating condition. As evident from FIG. 3, the phone/modem blocker 10 may include four or more fuses 22 at the discretion of an individual. It should be noted that the number of fuses 22 used within the phone/modem blocker 10 may vary significantly dependent upon the number of telephone/modem wires 35 to be protected by the phone/modem blocker 10.

In the embodiment depicted in FIGS. 2 and 3, two telephone/modem lines 36 are depicted having 4 shared wires 35, wherein each wire 35 utilizes four fuses 22. Each additional telephone and/or modem line 36 utilized within the phone/modem blocker 10 utilizes two additional fuses 22. Each fuse 22 may have any capacity as desired by an individual and are preferably 35A, 125 volt glass fuses which may be readily available from an electronics component source.

Referring to FIG. 3, one embodiment of the electronic circuit 26 used in conjunction with the phone/modem blocker 10 is illustrated. The electrical circuit 26 is illustrated for use in conjunction with four wires 35 which enter the circuit 26 from the input jack 13. The four wires 35 form two shared telephone/modem lines 36 which are connected to two out-put jacks 15. It should be noted that the electronic circuit 26 as depicted in FIG. 3 may be altered for use in the protection of a single phone line or for three or more telephone/modem lines 36 at the discretion of an individual. In order to add a phone line 36, a corresponding additional amount of fuses 22, Sidactors® 28, LED's 30, and test buttons 18 are utilized. It should be further noted that additional line receiving ports 12 will be required for releasable receiving engagement of each additional telephone/modem line 16.

Referring to FIG. 3, fuse 32 and 34 protect the first phone line 36a. The phone line 36a is always connected to the center two terminals 38 of jack 13. Sidactors® 42, 44 and 45, connect from tip-to-ground 46, tip-to-ring, and ring-to-ground 46 respectively. Any exposure of electric circuit 26 to voltage over 375 volts will cause Sidactors® 42, 44 and 45, to switch diverting current away from the output jacks 15.

Push button/test switch 50, resistor 52, and bi-directional indicator such as an LED 54 are preferably connected across phone line 36a such that the depressing of the push button test switch 50 will cause the bi-directional LED 54 to illuminate in the event that fuse 32 is in good operational condition and phone line 36 is intact to this point. Push button, test circuit 56, resistor 58, and bi-directional LED 60 are connected across a second phone or modem line 36b such that the depression of the push button test switch 56 will cause the bi-directional LED light 60 to illuminate only if fuse 34 is in good operational condition and phone line 36b is intact to this point. It should be noted that resistors 52 and 58 limit the current to the bi-directional LED's 54, 60 to a reasonable value, driven by the DC voltage provided from the phone service. Phone line 36b is preferably connected to the outer terminals 64 of the jack 13. Sidactors® 68, 70, and 72, preferably protect line 36b through fuses 74, 76 respectively. Push button/test switch 78, resistor 80, and bi-directional LED 82 are connected across phone line 62 such that the depression of test switch/button 78 will cause the bi-directional LED light 82 to light only if fuse 74 is in good operational condition and phone line 36b is intact at this point. Test switch/push button 84, resistor 86, and bi-directional LED 88 are connected across phone line 36b such that the depression of test switch/push button 84 will cause the bi-directional LED 88 to illuminate only if fuse 76 is in good operational condition and the phone line 36b is intact at this point.

The resistors 52, 58, 80, and 86, are preferably 5.1 k, 1/2 w resistors as may be commonly available from any electrical supplier. The bi-directional LED light sources 54, 60, 82, and 88, are preferably twin LED 3 mm light sources having a red wavelength. The Sidactor's® 42, 44, 45, 68, 70, and 72, may be Model No. P3100EB as available from Teccor Electronics, Inc.

Most lightening damage to electronic circuitry occurs through a telephone line. A lightening strike in the general area of a receptor site is capable of inducing a destructive high voltage spike on the telephone line. It is desirable to provide primary protection blocks to divert the high voltage spikes from reaching the printed circuit boards through an electrical ground. The high voltage surge must be shunted to ground preferably before it enters a building through a telephone wire.

The Sidactors® 42, 44, 45, 68, 70, and 72, are preferably the desired switches to provide for an electrical path or shunt to ground within the phone/modem blocker 10. Alternatively, thyristors and/or triacs may be used in place of the Sidactors® to provide for a desired electrical path or shunt to ground.

Sidactors® 42, 44, 45, 68, 70, and 72, are bi-lateral switches, similar to a triac without a gate connection. A Sidactor® may be triggered into conduction regardless of polarity, but only by an over voltage pulse. Sidactors® are often used as over voltage protection devices with clamping voltages from 20 to over 500 volts. Upon application of a voltage exceeding the breakdown voltage, the Sidactor® switches on through a negative or positive resistance region to a low on-stage voltage. Conduction will continue until the current is interrupted or drops below the minimum holding current. The Sidactor® may offer longer life and faster response (nanoseconds) than other types of protection and is able to respond without voltage overshoot. The Sidactor® is preferably as fast as a zener diode, while offering a much lower impedance (leakage current less than 5 μa) during conduction. Preferably the Sidactor® performs at high speeds (high dv/dt) providing optimal triggering to prevent power surge/power current damage to electronic circuitry.

A triac is an electronic relayer switch which is located either externally or fixed within the controller. A triac operates when it receives an electronic gate signal from the control circuitry. The triac then switches to its closed or on state thus providing a desired voltage path. In this situation, the triac would provide a voltage path to ground to prevent entry of excessive power currents or power surges into a dwelling via a phone line to prevent damage to electronic circuitry.

A thyristor is generally a solid state semiconductor switch which acts to open a circuit capable of withstanding the rated voltage until the circuit is triggered. Once the circuit is triggered the thyristor becomes a low-impedance current path until either the current stops or falls below the minimum value called the holding current. A thyristor may only conduct current in one direction, much like a rectifier, whereas a triac may conduct current in both directions.

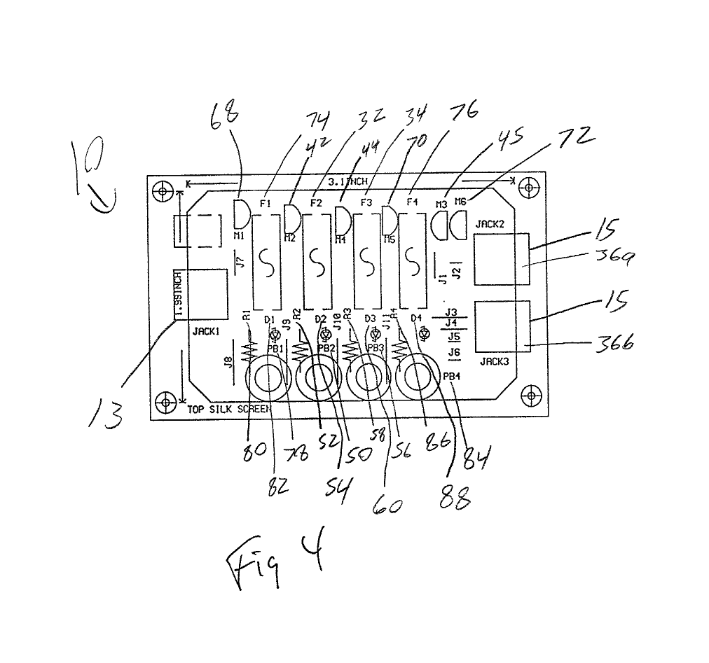

In FIG. 4 a top down view of the silk screen of an embodiment of a circuit board of the blocker 10 is shown which corresponds to the elements of the circuit diagram of FIG. 3.

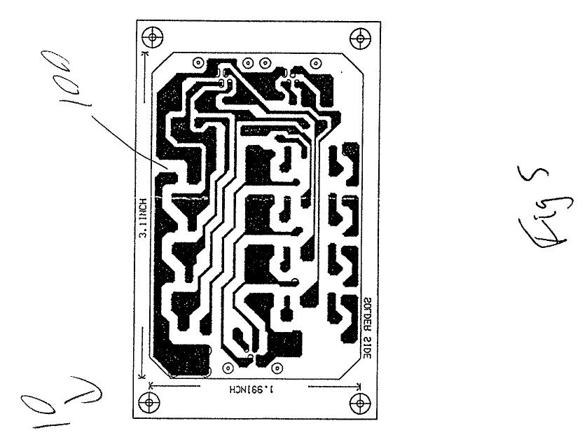

In FIG. 5 an embodiment of a circuit board 100 of the blocker 10 is shown.

In addition to being directed to the specific combinations of features claimed below, the invention is also directed to embodiments having other combinations of the dependent features claimed below and other combinations of the features described above.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below (e.g. claim 3 may be taken as alternatively dependent from claim 2; claim 5 may be taken as alternatively dependent on claim 3, claim 6 may be taken as alternatively dependent from claim 3; claim 7 may be taken as alternatively dependent from claims 3, 5 or 6; etc.).

What is claimed is:

1. A telephone line protection device comprising:
an input jack having at least four input conductors;
at least two output jacks, each output jack being conductively connected to the at least four input conductors;
each input conductor including a fuse between the input jack and the at least two output jacks;
two of the at least four input conductors forming a first phone line and two different conductors of the at least four input conductors forming a second phone line;
a first solid state electrical component (M4) having first and second contacts and being responsive to an overvoltage for providing a conduction path between the first and second contacts, the first contact being connected to one of the two input conductors forming the first phone line and the second contact being connected to a ground;
a second solid state electrical component (M2) having first and second contacts and being responsive to an overvoltage for providing a conduction path between the first and second contacts, the first contact being connected to the other of the two input conductors forming the first phone line and the second contact being connected to the ground;
a third solid state electrical component (M3) having first and second contacts and being responsive to an overvoltage for providing a conduction path between the first and second contacts, the first contact being connected to the input line connected to the first solid state electrical component (M4) and the second contact being connected to the input line connected to the second solid state electrical component (M2);
a fourth solid state electrical component (M5) having first and second contacts and being responsive to an overvoltage for providing a conduction path between the first and second contacts, the first contact being connected to one of the two input conductors forming the second phone line and the second contact being connected to the ground;
a fifth solid state electrical component (M1) having first and second contacts and being responsive to an overvoltage for providing a conduction path between the first and second contacts, the first contact being connected to the other of the two input conductors forming the second phone line and the second contact being connected to the ground;
a sixth solid state electrical component (M6) having first and second contacts and being responsive to an overvoltage for providing a conduction path between the first and second contacts, the first contact being connected to the input line connected to the fourth solid state electrical component (M5) and the second contact being connected to the input line connected to the fifth solid state electrical component (M1).

2. The telephone line protection device of claim 1 wherein the input jack is connected to a telephone line near the point where the telephone line enters a structure.

3. The telephone line protection device of claim 2 wherein each of the at least four input lines includes a line test circuit.

4. The telephone line protection device of claim 3 wherein the line test circuit is activated by a push button.

5. The telephone line protection device of claim 4 wherein the line test circuit is connected to an indicator which signals if the line is operational.

6. The telephone line protection device of claim 5 wherein the indicator is an LED which illuminates if the line is operational.
